(19) United States
(12) Patent Application Publication
(10) Pub. No.: US 2010/0201755 A1
(43) Pub. Date: Aug. 12, 2010

(54) LIQUID EJECTION HEAD, LIQUID EJECTION APPARATUS AND IMAGE FORMING APPARATUS

(75) Inventor: Tsuyoshi Mita, Ashigarakami-gun (JP)

Correspondence Address: FISH & RICHARDSON P.C., PO BOX 1022, MINNEAPOLIS, MN, 55440-1022, US

(73) Assignee: FUJIFILM Corporation

(21) Appl. No.: 12/703,121

(22) Filed: Feb. 9, 2010

(30) Foreign Application Priority Data
Feb. 10, 2009 (JP) 2009028620

(51) Int. Cl. B41J 2/045

(52) U.S. Cl. 347/71

(57) ABSTRACT

A liquid ejection head includes: a flow channel unit including a plurality of pressure chambers arranged along a plane surface; and a piezoelectric actuator for changing volume of the plurality of pressure chambers so as to pressurize liquid in the plurality of pressure chambers, the piezoelectric actuator comprising: a diaphragm forming one wall surface of the plurality of pressure chambers; a plurality of piezoelectric bodies arranged on first regions of the diaphragm that are within a surface of the diaphragm opposite from the plurality of pressure chambers, the first regions overlapping with the plurality of pressure chambers respectively when viewed in a direction perpendicular to the plane surface; a plurality of individual electrodes arranged on second regions of one surface of the plurality of piezoelectric bodies respectively, the second regions overlapping with marginal parts of the plurality of pressure chambers that are non-central parts of the plurality of pressure chambers when viewed in the direction perpendicular to the plane surface; a common electrode arranged on another surface of the plurality of piezoelectric bodies; and a reinforcing member arranged on third regions of the diaphragm that are within the surface of the diaphragm opposite from the plurality of pressure chambers, the third regions respectively overlapping with pressure chamber partition portions between the plurality of pressure chambers when viewed in the direction perpendicular to the plane surface.

### BACKGROUND OF THE INVENTION

1. Field of the Invention

The present invention relates to a liquid ejection head, a liquid ejection apparatus and an image forming apparatus, and more particularly to technology for improving the driving efficiency of a piezoelectric actuator while preventing cross talk occurring between adjacent pressure chambers, in a liquid ejection head which employs the flexing vibration mode of piezoelectric elements.

2. Description of the Related Art

A typical example of a liquid ejection head is an inkjet head in which a diaphragm constitutes one side surface of a pressure chamber which is connected to a nozzle, and this diaphragm is caused to deform by means of a piezoelectric element so as to apply pressure to the ink inside the pressure chamber, ejecting an ink droplet from the nozzle. In other words, in this inkjet head, an ink droplet is ejected from a nozzle by pressurizing ink inside a pressure chamber by means of a piezoelectric actuator constituted by a diaphragm and the piezoelectric element.

Generally known types of a piezoelectric inkjet head of this kind are: heads which employ a longitudinal vibration mode of extension and contraction in the axial direction of the piezoelectric element and heads which employ a flexing vibration (i.e. lateral vibration) mode. Of these, the latter type is advantageous in that it enables the overall thickness of the head to be reduced, as well as being able to introduce a large number of thin film processes in the head manufacturing process, and therefore being well suited to integration.

Here, examples of the composition of an inkjet head using a flexing distortion mode will be described with reference to FIG. 18A to FIG. 20B.

Firstly, the compositional example shown in FIGS. 18A and 18B has a piezoelectric actuator 982 comprising a diaphragm 956 disposed so as to cover a plurality of pressure chambers 952 and piezoelectric elements 958 provided respectively in positions opposing the pressure chambers 952 on the diaphragm 956. Each of the piezoelectric elements 958 is constituted by a piezoelectric body 959 and an individual electrode 960 provided on the upper surface of same, and the diaphragm 956 also acts as a common electrode for the piezoelectric elements 958. When a drive voltage is applied to the individual electrode 960 of a piezoelectric element 958, the resulting potential difference created between the individual electrode 960 and the diaphragm 956 functioning as a common electrode causes an electric field to acts in the thickness direction of the piezoelectric body 959 which is sandwiched between the individual electrode 960 and the diaphragm 956. In this case, provided that the direction of polarization of the piezoelectric body 959 is in the same thickness direction as the orientation of the electric field, the piezoelectric body 959 is contracted in a horizontal direction which is perpendicular to the direction of polarization. Due to this contraction of the piezoelectric body 959, the diaphragm 956 deforms so as to protrude toward the pressure chamber 952 side, thereby reducing the capacity in the pressure chamber 952, and the ink inside the pressure chamber 952 is pressurized and an ink droplet is ejected from the nozzle (not illustrated) which is connected to the pressure chamber 952.

However, in the compositional example shown in FIGS. 18A and 18B, there is a problem in that when the diaphragm 956 deforms due to the contraction of the piezoelectric body 959, the partition portions 964a between the pressure chambers 952 (hereinafter, called the “pressure chamber partition portions”) are liable to bend toward the inner side of the pressure chambers 952 and therefore mechanical cross talk is liable to occur between adjacent pressure chambers. In this case, the amount of displacement of the diaphragm tends to become large, and the cross talk tends to become large. Furthermore, if the flexing vibration mode is to be used, then the piezoelectric elements need to have a surface area of a certain size, and there is still a requirement for the development of a piezoelectric actuator having stable operation and good driving efficiency, even when formed at higher density and in thin film layers.

On the other hand, the compositional example shown in FIGS. 19A and 19B improves upon the compositional example shown in FIGS. 18A and 18B, and as observed in Japanese Patent Application Publication No. 2000-246898, for example, a reinforcing member 984 is provided at positions on the diaphragm 956 opposing the pressure chamber partition portions 964a.

However, in the compositional example shown in FIGS. 19A and 19B, although mechanical cross talk occurring between adjacent pressure chambers can be prevented since the rigidity of the pressure chamber partition portions 964a is improved by the reinforcing members 984, a problem occurs in that the amount of displacement of the diaphragm 956 becomes smaller conversely, as the rigidity of the pressure chamber partition portions 964a becomes greater, and therefore the drive voltage for obtaining the desired amount of displacement must be increased, leading to decline in the driving efficiency of the piezoelectric actuators 982. That is, the amount of displacement of the diaphragm tends to become small, and the cross talk tends to become small.

On the other hand, the compositional example shown in FIGS. 20A and 20B improves upon the compositional example shown in FIGS. 18A and 18B from a different viewpoint, and as shown in Japanese Patent Application Publication No. 2006-150948, for example, an individual electrode 960 is formed in a ring shape in the non-central part of each pressure chamber 952 in plan view, which overlaps with the marginal part of each pressure chamber, so as to improve the driving efficiency of the piezoelectric actuators 982. By means of this composition example, if a drive voltage is applied to a ring-shaped individual electrode 960, then the ring-shaped region of the piezoelectric body 959 sandwiched between the ring-shaped individual electrode 960 and the diaphragm 956 that forms a common electrode contracts in a horizontal direction which is perpendicular to the direction of polarization (the thickness direction of the piezoelectric body 959). Due to the contraction of this ring-shaped region of the piezoelectric body 959, the diaphragm 956 deforms so as to be convex toward the opposite side from the pressure chamber 952, thereby increasing the capacity inside the pressure chamber 952 and producing a pressure wave inside the pressure chamber 952. Moreover, if the application of voltage to the individual electrode 960 is halted at a time when the pressure wave is turning in the positive direction, then the diaphragm 956 returns to its original shape and the volume inside the pressure chamber 952 decreases, and since the pressure wave caused by the increase in the capacity of the pressure chamber 952 described above and the pressure wave occurring due to the returning action of the diaphragm 956 combine together, a large pressure is applied to the ink inside the pressure chamber 952. Consequently, it is possible to apply a high pressure to the ink by means of a relatively low drive voltage, and the driving efficiency of the piezoelectric actuator 982 is thereby increased.

However, in the compositional example shown in FIGS. 20A and 20B, similarly to the compositional example shown in FIGS. 18A and 18B, when the diaphragm 956 deforms due to the contraction of the ring-shaped region of the piezoelectric body 959, the pressure chamber partition portions 964a are liable to bend toward the inner side of the pressure chambers 952, and hence there is a problem in that mechanical cross talk is liable to occur between the adjacent pressure chambers. That is, the amount of displacement of the diaphragm tends to become large, and the cross talk tends to become large. Furthermore, by means of the pressure chamber partition portions 964a bending toward the inner side of the pressure chamber 952, the deformation of the portion of the diaphragm 956 corresponding to the central part of the ring-shaped individual electrode 960 becomes smaller and this also causes the amount of displacement of the diaphragm 956 to decrease.

In recent years, there have been advances in increasing the density and reducing the size of inkjet heads using the flexing distortion mode. As the result of the high density arrangement for, for example, the pressure chambers and piezoelectric elements, a thinner pressure chamber partition portion has been developed. Therefore, mechanical cross talk occurring between adjacent pressure chambers and decline in the driving efficiency of the piezoelectric actuator are more pronounced problems, leading to decline in ejection efficiency and causing the occurrence of ejection fluctuations, and the like.

However, as described above, the composition example shown in FIGS. 19A and 19B and the compositional example shown in FIGS. 20A and 20B display beneficial effects which are mutually contradictory, and consequently at present there does not exist any technology which combines these compositional examples, and furthermore, the usefulness thereof is completely unknown.

### SUMMARY OF THE INVENTION

The present invention has been contrived in view of the foregoing circumstances, an object thereof being to provide a liquid ejection head, a liquid ejection apparatus and an image forming apparatus in order to prevent mechanical cross talk from occurring between adjacent pressure chambers and improve driving efficiency of a piezoelectric actuator.

In order to attain an object described above, one aspect of the present invention is directed to a liquid ejection head comprising: a flow channel unit including a plurality of pressure chambers arranged along a plane surface; and a piezoelectric actuator for changing volume of the plurality of pressure chambers so as to pressurize liquid in the plurality of pressure chambers, the piezoelectric actuator comprising: a diaphragm forming one wall surface of the plurality of pressure chambers; a plurality of piezoelectric bodies arranged on first regions of the diaphragm that are within a surface of the diaphragm opposite from the plurality of pressure chambers, the first regions overlapping with the plurality of pressure chambers respectively when viewed in a direction perpendicular to the plane surface; a plurality of individual electrodes arranged on second regions of one surface of the plurality of piezoelectric bodies respectively, the second regions overlapping with marginal parts of the plurality of pressure chambers that are non-central parts of the plurality of pressure chambers when viewed in the direction perpendicular to the plane surface; a common electrode arranged on another surface of the plurality of piezoelectric bodies; and a reinforcing member arranged on third regions of the diaphragm that are within the surface of the diaphragm opposite from the plurality of pressure chambers, the third regions respectively overlapping with pressure chamber partition portions between the plurality of pressure chambers when viewed in the direction perpendicular to the plane surface.

According to this aspect of the invention, by composing the individual electrodes formed on one surface of the piezoelectric bodies in a ring-like shape corresponding to the shape of the pressure chambers and arranging the reinforcing member at positions corresponding to the pressure chamber partition portions, it is possible to prevent mechanical cross talk between adjacent pressure chambers, as well as being able to further improve the driving efficiency of the piezoelectric actuator in comparison with a case where reinforcing members are not provided.

Desirably, the plurality of pressure chambers are two-dimensionally arranged in a first direction and a second direction that is oblique to the first direction and is not perpendicular to the first direction, and the reinforcing member is arranged on the third regions that respectively overlap with the pressure chamber partition portions between the plurality of pressure chambers that are adjacent in at least one of the first direction and the second direction when viewed in the direction perpendicular to the plane surface.

According to this aspect of the invention, it is possible to improve the effect of preventing mechanical cross talk between pressure chambers that are adjacent in the direction in which the pressure chamber partition portions are provided.

Desirably, the reinforcing member is an elongated member which is arranged in parallel with a row of the pressure chambers arranged in the first direction or the second direction.

According to this aspect of the invention, it is possible further to improve the rigidity of the pressure chamber partition portions which are disposed between the rows of pressure chambers, and to improve the effect of preventing the mechanical cross talk.

Desirably, the reinforcing member is a lattice-shaped member which encompasses entire periphery parts of the plurality of pressure chambers respectively when viewed in the direction perpendicular to the plane surface.

According to this aspect of the invention, it is possible to prevent effectively mechanical cross talk between pressure chambers which are adjacent in a first direction and a second direction, respectively, and to improve further the drive efficiency of the piezoelectric actuator, with the piezoelectric bodies uniformly extending or and contracting.

Desirably, the reinforcing member is divided into comb-tines-shaped members.

According to this aspect of the invention, since the lattice-shaped member is divided into a plurality of comb-tines-shaped members, it is possible to prevent vibration from being transmitted between the comb-tines-shaped members, and the mechanical cross talk can be prevented yet further.

Desirably, the reinforcing member is made from a tabular member having pore portions that are arranged respectively in fourth regions of the tabular member, the fourth regions overlapping with the plurality of pressure chambers when viewed in the direction perpendicular to the plane surface.

According to this aspect of the invention, similar beneficial effects to the above-described aspect can be obtained, and it is possible to prevent effectively mechanical cross talk between pressure chambers which are adjacent in a first direction and a second direction respectively, and to improve further the drive efficiency of the piezoelectric actuator, with the piezoelectric bodies uniformly extending or and contracting.

Desirably, the reinforcing member is composed of individual reinforcing members which are each provided with respect to each of the plurality of pressure chambers.

Desirably, the individual reinforcing members are U-shaped members which surround periphery parts of the plurality of pressure chambers respectively when viewed in the direction perpendicular to the plane surface.

Desirably, the individual reinforcing members are ring-shaped members which encompass entire periphery parts of the plurality of pressure chambers respectively when viewed in the direction perpendicular to the plane surface.

According to these aspects of the invention, the reinforcing member may be individual reinforcing members which are provided respectively for the plurality of pressure chambers. Furthermore, desirably, the individual reinforcing members are U-shaped members and more desirably, ring-shaped members.

Desirably, the reinforcing member has a cavity configuration in which recesses for housing the plurality of piezoelectric bodies and the plurality of individual electrodes that are arranged opposite from the plurality pressure chambers respectively.

According to this aspect of the invention, it is possible to obtain a beneficial effect in protecting the piezoelectric elements against humidity.

Desirably, the reinforcing member seals the plurality of piezoelectric bodies and the plurality of individual electrodes in the recesses in such a manner that an ambient air is prevented from leaking into the recesses.

Desirably, the liquid ejection head further comprises a protect film provided on the piezoelectric actuator in such a manner that the protect film protects the piezoelectric actuator from at least the liquid.

Desirably, the plurality of individual electrodes have a ring shape.

Desirably, the plurality of piezoelectric bodies are made by sputtering.

Desirably, the plurality of piezoelectric bodies employ a flexing vibration mode.

In order to attain an object described above, another aspect of the present invention is directed to a liquid ejection apparatus comprising any one of the liquid ejection heads defined above, wherein in the liquid ejection head, the plurality of individual electrodes on the second regions of the one surface of the plurality of piezoelectric bodies are arranged opposite from the diaphragm, the common electrode is grounded, and the plurality of piezoelectric bodies are polarized in a direction from the diaphragm toward the plurality of individual electrodes, and wherein the liquid ejection apparatus further comprises a voltage application device which applies a voltage having a driving voltage waveform with negative potential in such a manner that an electric field acting in a same direction as the direction in which the plurality of piezoelectric bodies are polarized is produced only during operation to eject the liquid.

According to this aspect of the invention, since an electric field does not act on the piezoelectric bodies normally, when an ink ejection operation is not being performed, then it is possible to prevent deterioration of the piezoelectric bodies, which means that reliability is improved.

Desirably, the liquid ejection apparatus further comprises a controller controlling the voltage application device in such a manner that a plurality of pressure waves in the liquid in the plurality of pressure chambers which are produced by volume change of the pressure chambers caused by the piezoelectric actuator are combined together to eject the liquid from the liquid ejection head.

In order to attain an object described above, another aspect of the present invention is directed to an image forming apparatus comprising any one of the liquid ejection heads defined above.

According to this aspect of the invention, the ejection stability of the liquid ejection head is improved by preventing mechanical cross talk and improving the driving efficiency of the piezoelectric actuator, and an image having excellent image quality can be formed.

According to the present invention, by composing the individual electrodes formed on one surface of the piezoelectric bodies in a ring-like shape corresponding to the shape of the pressure chambers and arranging a reinforcing member at positions corresponding to the pressure chamber partition portions, it is possible to prevent mechanical cross talk between adjacent pressure chambers, as well as being able to further improve the driving efficiency of the piezoelectric actuator in comparison with a case where reinforcing members are not provided.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1 is a general schematic drawing of an inkjet recording apparatus relating to one embodiment of the present invention;

FIG. 2 is a principal plan diagram showing the peripheral area of a printing unit in the inkjet recording apparatus in FIG. 1;

FIG. 3 is a plan diagram showing an example of the structure of the principal part of an inkjet head;

FIG. 4 is a plan diagram showing a further example of the structure of the principal part of an inkjet head;

FIG. 5 is a cross-sectional diagram along line 5-5 in FIG. 3;

FIG. 6 is a plan diagram showing a piezoelectric actuator of an inkjet head;

FIG. 7 is an enlarged plan diagram showing a portion of FIG. 6;

FIGS. 8A and 8B are cross-sectional diagrams along line 8-8 in FIG. 7;

FIG. 9 is a diagram showing reinforcing members according to a first modification example;

FIG. 10 is a diagram showing reinforcing members according to a second modification example;

FIG. 11 is a diagram showing reinforcing members according to a third modification example;

FIG. 12 is a diagram showing reinforcing members according to a fourth modification example;

FIG. 13 is a diagram showing reinforcing members according to a fifth modification example;

FIG. 14 is a diagram showing reinforcing members according to a sixth modification example;

FIG. 15 is a diagram showing reinforcing members according to a seventh modification example;

FIG. 16 is a diagram showing a drive voltage waveform supplied to the piezoelectric actuator according to an embodiment of the present invention;

FIG. 17 is a principal block diagram showing the control system of an inkjet recording apparatus;

FIGS. 18A and 18B are diagrams showing an example of the structure of an inkjet head in the related art;

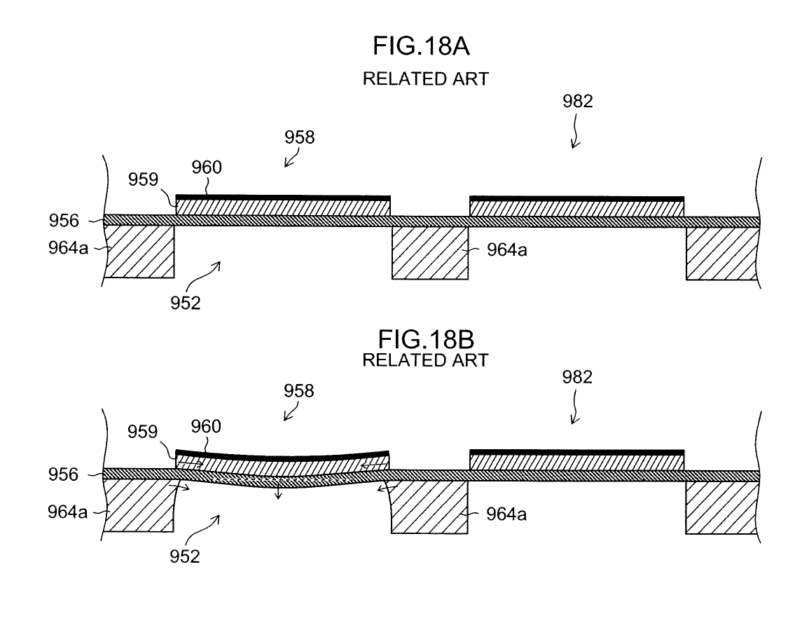

FIGS. 19A and 19B are diagrams showing a further example of the structure of an inkjet head in the related art;

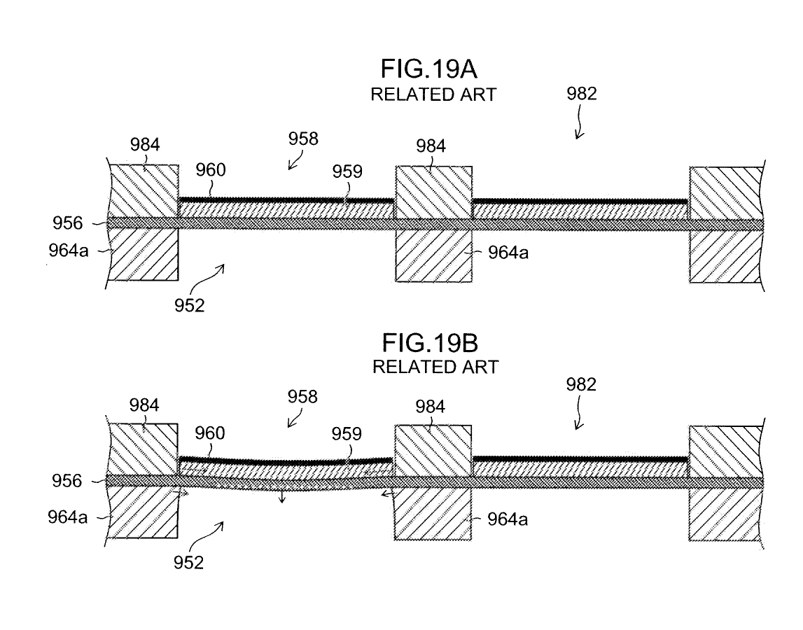

FIGS. 20A and 20B are diagrams showing yet a further example of the structure of an inkjet head in the related art; and

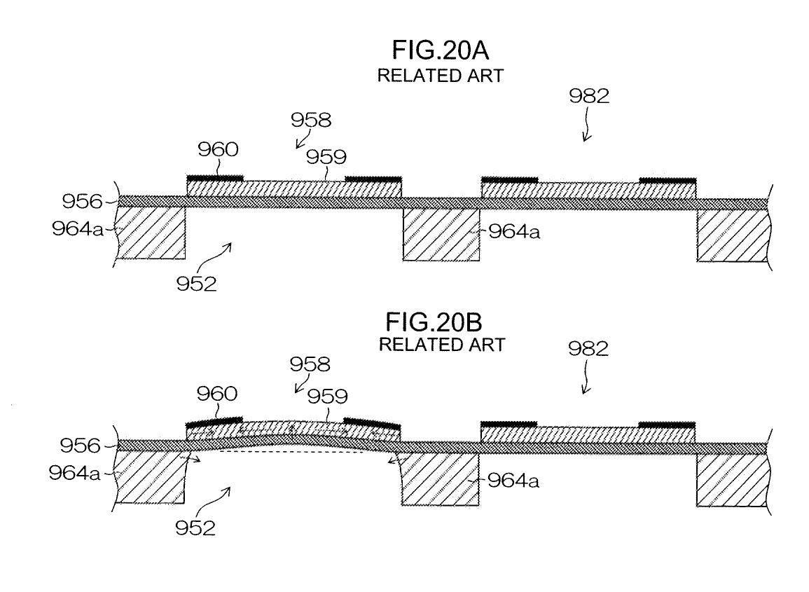

FIG. 21 is a diagram showing a drive voltage waveform supplied to a piezoelectric actuator in the related art.

### DETAILED DESCRIPTION OF THE PREFERRED EMBODIMENTS

### General Configuration of Inkjet Recording Apparatus

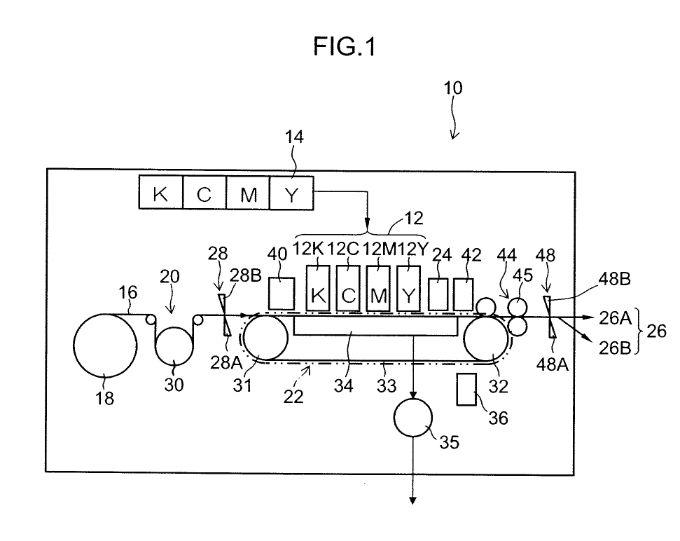

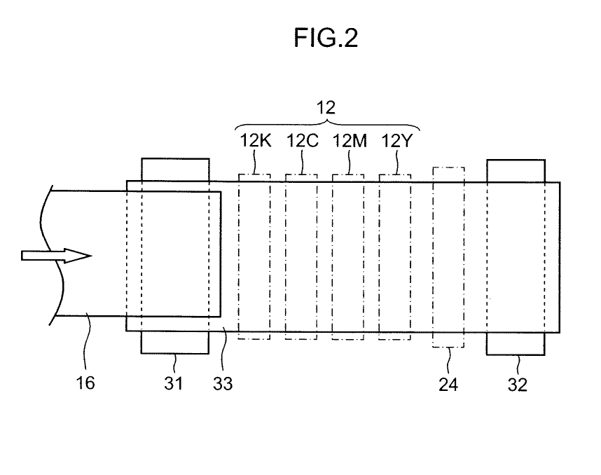

FIG. 1 is a schematic diagram showing a general configuration of an inkjet recording apparatus according to an embodiment of the present invention. The inkjet recording apparatus 10 illustrated in FIG. 1 includes: a printing unit 12 having a plurality of inkjet heads 12K, 12C, 12M, and 12Y (not shown in FIG. 1, but shown in FIG. 2) provided respectively for ink colors of black (K), cyan (C), magenta (M), and yellow (Y); an ink storing and loading unit 14 for storing inks of K, C, M and Y to be supplied to the inkjet heads 12K, 12C, 12M, and 12Y; a paper supply unit 18 for supplying recording paper 16; a decurling unit 20 removing curl in the recording paper 16; a suction belt conveyance unit 22 disposed facing the nozzle face (ink-droplet ejection face) of the printing unit 12, for conveying the recording paper 16 while keeping the recording paper 16 flat; a print determination unit 24 for reading the printed result produced by the printing unit 12; and a paper output unit 26 for outputting image-printed recording paper (printed matter) to the exterior.

In FIG. 1, a magazine for rolled paper (continuous paper) is shown as an example of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of the configuration in which roll paper is used, a cutter 28 is provided as shown in FIG. 1, and the continuous paper is cut into a desired size by the cutter 28. The cutter 28 has a stationary blade 28A, whose length is not less than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyor pathway. When cut papers are used, the cutter 28 is not required.

In the case of a composition where recording papers of a plurality of types can be used, desirably, an information recording body, such as a bar code or a wireless tag, which records information about the paper type is attached to the magazine, and the type of paper used is identified automatically by reading in the information on this information recording body by means of a prescribed reading apparatus, the ejection of ink being controlled so as to achieve suitable ink ejection in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. In this, the heating temperature is preferably controlled in such a manner that the medium has a curl in which the surface on which the print is to be made is slightly rounded in the outward direction.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the printing unit 12 and the sensor face of the print determination unit 24 forms a flat plane.

The belt 33 has a width that is greater than the width of the recording paper 16, and a plurality of suction apertures (not shown) are formed on the belt surface. A suction chamber 34 is disposed in a position facing the nozzle surface of the printing unit 12 and the sensor surface of the print determination unit 24 on the interior side of the belt 33, which is set around the rollers 31 and 32, as shown in FIG. 1. The suction chamber 34 provides suction with a fan 35 to generate a negative pressure, and the recording paper 16 on the belt 33 is held by suction.

The belt 33 is driven in the clockwise direction in FIG. 1 by the motive force of a motor (not shown) being transmitted to at least one of the rollers 31 and 32, which the belt 33 is set around, and the recording paper 16 held on the belt 33 is conveyed in the paper conveyance direction (in the direction from left to right in FIG. 1).

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, examples thereof include a configuration in which the belt 33 is nipped with cleaning rollers such as a brush roller and a water absorbent roller, an air blow configuration in which clean air is blown onto the belt 33, or a combination of these. In the case of the configuration in which the belt 33 is nipped with the cleaning rollers, it is preferable to make the line velocity of the cleaning rollers different than that of the belt 33 to improve the cleaning effect.

The inkjet recording apparatus 10 can have a roller nip conveyance mechanism, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

The printing unit 12 is a so-called “full line head” in which a line head having a length corresponding to the maximum paper width is arranged in a direction (main scanning direction) that is perpendicular to the paper conveyance direction (sub scanning direction). Each of the printing heads 12K, 12C, 12M, and 12Y constituting the printing unit 12 is constituted by a line head, in which a plurality of ink ejection ports (nozzles) are arranged along a length that exceeds at least one side of the maximum-size recording paper 16 intended for use in the inkjet recording apparatus 10 (see FIG. 2).

The printing heads 12K, 12C, 12M, and 12Y are arranged in the order of black (K), cyan (C), magenta (M), and yellow (Y) from the upstream side, along the feed direction of the recording paper 16 (hereinafter, referred to as the sub-scanning direction). A color image can be formed on the recording paper 16 by ejecting the inks from the printing heads 12K, 12C, 12M, and 12Y, respectively, onto the recording paper 16 while conveying the recording paper 16.

By adopting the printing unit 12 in which the full line heads covering the full paper width are provided for the respective ink colors in this way, it is possible to record an image on the full surface of the recording paper 16 by performing just one operation of relatively moving the recording paper 16 and the printing unit 12 in the paper conveyance direction (the sub-scanning direction), in other words, by means of a single sub-scanning action. Higher-speed printing is thereby made possible and productivity can be improved in comparison with a shuttle type head configuration in which a head reciprocates in a direction (the main scanning direction) orthogonal to the paper conveyance direction.

Although the configuration with the KCMY four standard colors is described in the present embodiment, combinations of the ink colors and the number of colors are not limited to those. Light inks or dark inks can be added as required. For example, a configuration is possible in which heads for ejecting light-colored inks such as light cyan and light magenta are added. Furthermore, there are no particular restrictions of the sequence in which the heads of respective colors are arranged.

As illustrated in FIG. 1, the ink storing and loading unit 14 has tanks (main tanks) which store inks of colors corresponding to the respective heads 12K, 12C, 12M and 12Y of the printing unit 12, and the tanks are respectively connected to and communicated with the heads 12K, 12C, 12M and 12Y via channels (not illustrated). Moreover, the ink storing and loading unit 14 also has a notifying device (display device, alarm generating device, or the like) for generating a notification if the remaining amount of ink has become low, as well as having a mechanism for preventing incorrect loading of ink of the wrong color.

The print determination unit 24 has an image sensor (line sensor or the like) for capturing an image of the ink-droplet deposition result of the printing unit 12, and functions as a device to check for ejection defects such as clogs of the nozzles or the variation in the droplet ejection speed (ejection characteristics) of the nozzles based on the ink-droplet deposition images read by the image sensor.

The print determination unit 24 of the present embodiment is configured with a line sensor having rows of photoelectric transducing elements with a width that is greater than at least the ink ejection width of each of the heads 12K, 12C, 12M and 12Y (the image recording width of the recording paper 16). This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 determines the ejection from the respective heads 12K, 12C, 12M and 12Y by reading in a test pattern which has been printed by the heads of the respective colors. The ejection determination includes the presence of ejection, measurement of the dot size, and measurement of the dot landing position.

A post drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown, the paper output unit 26A for the target prints is provided with a sorter for collecting prints according to print orders.

### Structure of Inkjet Head

Next, the structure of the heads 12K, 12C, 12M and 12Y mounted on the inkjet recording apparatus 10 illustrated in FIG. 1 will be described. The heads 12K, 12C, 12M and 12Y of the respective ink colors have the same structure, and a reference numeral 50 is hereinafter designated to any of the heads.

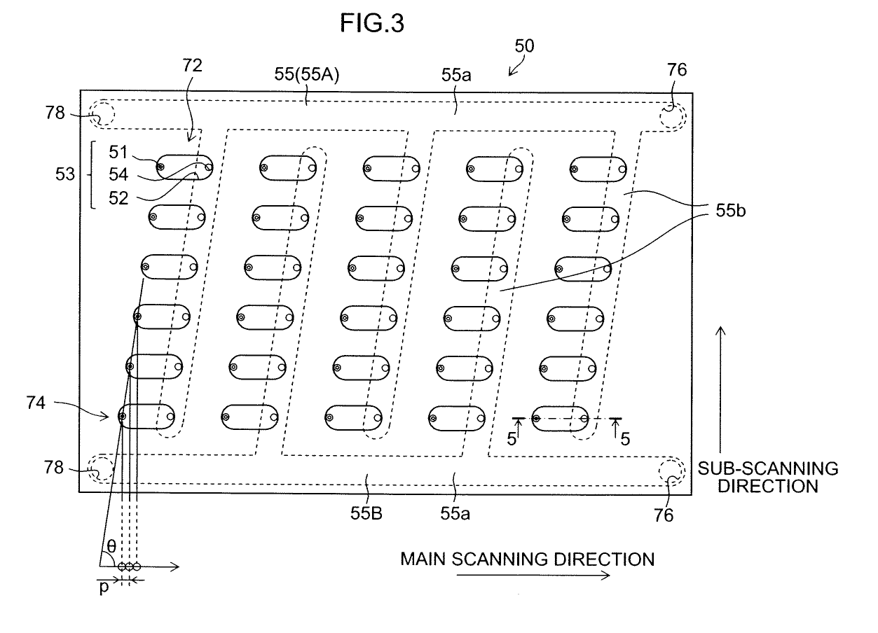

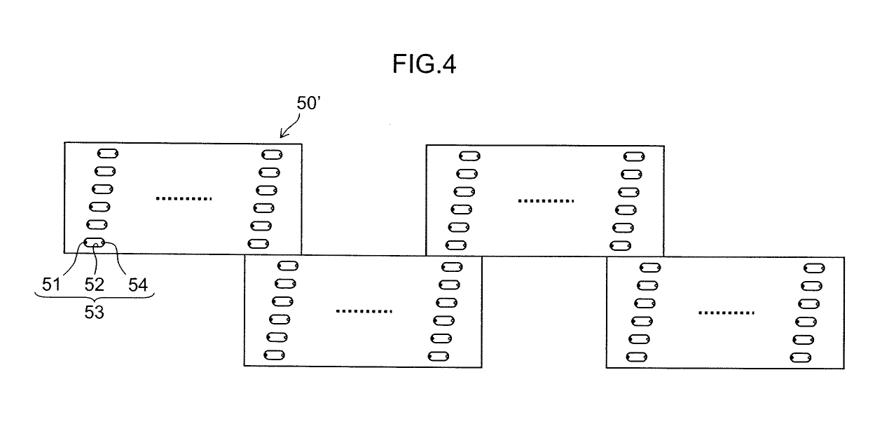

FIG. 3 is a planar view illustrating a structural example of a substantial part of the head 50. FIG. 4 is a planar view illustrating another structural example of the head 50.

The nozzle pitch in the head 50 should be minimized in order to maximize the density of the dots formed on the surface of the recording paper. As illustrated in FIG. 3, the head 50 according to the present embodiment has a structure in which a plurality of ink chamber units 53, each comprising a nozzle 51 forming an ink droplet ejection hole, a pressure chamber 52 corresponding to the nozzle 51, and the like, are disposed two-dimensionally in the form of a staggered matrix, and hence the effective nozzle interval (the projected nozzle pitch) as projected in the lengthwise direction of the head (the main scanning direction perpendicular to the paper conveyance direction) is reduced and high nozzle density is achieved.

The mode of forming one or more nozzle rows through a length corresponding to the entire width of the recording paper 16 in a direction substantially perpendicular to the paper conveyance direction is not limited to the example described above. For example, instead of the configuration illustrated in FIG. 3, as illustrated in FIG. 4, a line head having nozzle rows of a length corresponding to the entire width of the recording paper 16 can be formed by arranging and combining, in a staggered matrix, short head blocks (head chips) 50′ having a plurality of nozzles 51 arrayed in a two-dimensional fashion. Furthermore, although not shown in the drawings, it is also possible to compose a line head by arranging short heads in one row.

The plane surface shape of the pressure chambers 52 which are provided so as to correspond to the nozzles 51 is a substantially oval shape (substantially elliptical shape) having a long axis in the main scanning direction, and a nozzle 51 and a supply port (connection hole) 54 are provided in the respective end portions of the pressure chamber in the longitudinal direction. As described hereinafter, the pressure chambers 52 are connected respectively to the corresponding nozzles 51, as well as being connected to a common flow channel 55 via supply ports 54.

The common flow channel 55 (55A, 55B) has a comb-tines shape in planar view as shown in FIG. 3. This common flow channel 55 comprises a main flow section 55a which extends in the lengthwise direction of the head (main scanning direction) and a plurality of branch flow sections 55b which extend in an oblique direction that is not perpendicular to the main scanning direction, from the main flow section 55a. The branch flow sections 55b are disposed so as to overlap in planar view with the end portions on one side (the right-side portions in FIG. 3) of the pressure chambers 52 in the lengthwise direction of the pressure chamber rows 72 (hereinafter, “first pressure chamber rows”) which are arranged in an oblique direction that is not perpendicular to the main scanning direction. The respective main flow sections 55a of the first common flow channel 55A and the second common flow channel 55B are disposed respectively in both end portions in the sub-scanning direction which corresponds to the short-length direction of the head. The respective branch flow sections 55b which branch respectively from these common flow channels 55A and 55B are arranged alternately in the main scanning direction. An ink supply port 76 and an ink discharge port 78 are provided respectively in either end portion, in the main scanning direction, of the main flow sections 55a of the respective common flow channels 55A and 55B.

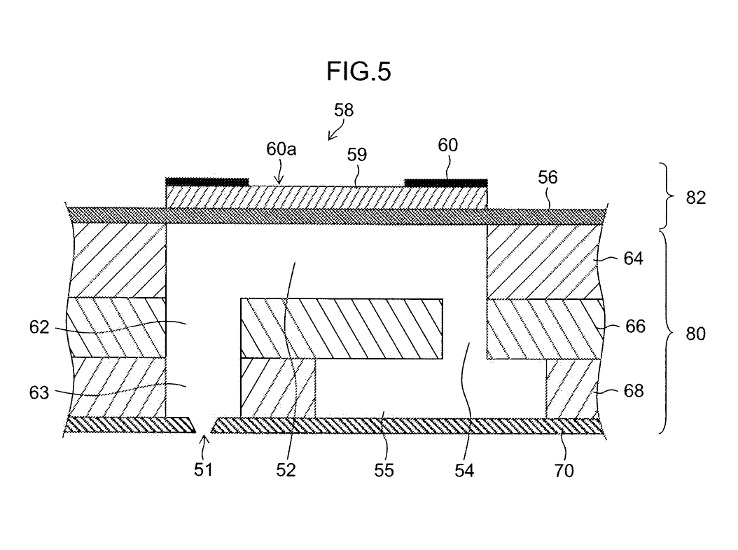

FIG. 5 is a cross-sectional diagram showing one portion of a head 50 (a cross-sectional diagram along line 5-5 in FIG. 3). As shown in FIG. 5, this head 50 is principally constituted by a flow channel unit 80 in which ink flow channels, such as pressure chambers 52, are formed, and a piezoelectric actuator 82 which is disposed on the upper surface (pressure chamber opening surface) of this flow channel unit 80.

The flow channel unit 80 is composed by bonding together, in a laminated state, a pressure chamber plate 64, a spacer plate 66, a manifold plate 68 and a nozzle plate 70. These plates 64 to 70 are thin plate-shaped members having a substantially rectangular shape of which the lengthwise direction is a direction (main scanning direction) perpendicular to the paper conveyance direction (sub-scanning direction). Of these plates, the pressure chamber plate 64, the spacer plate 66 and the manifold plate 68 are made of a silicon material, such as Si, SiO₂, SiN, quartz glass, or the like, or a metal material, such as stainless steel. Furthermore, the nozzle plate 70 is made of a resin material, such as polyimide, or a metal material, such as stainless steel, or Si.

A plurality of pressure chambers (pressure chamber holes) 52 are formed in the pressure chamber plate 64. The planar shape of the pressure chambers 52 is a substantially oval shape (substantially elliptical shape) having a long axis in the main scanning direction, as described above, and the size of the pressure chambers in the long axis direction is 300 μm, for example. The pressure chambers 52 are open to the upper side and the diaphragm 56 is disposed so as to cover the pressure chambers 52. More specifically, one wall surface of the pressure chambers 52 is constituted by the diaphragm 56.

Connecting holes 62 and 54 are formed respectively in the spacer plate 66 in positions which overlap with both end portions, in the lengthwise direction, of each of the pressure chambers 52. Furthermore, the common flow channel 55 (corresponding to the branch flow sections 55b in FIG. 3) is formed in the manifold plate 68 at a position overlapping with one end portion, in the lengthwise direction, of each of the pressure chambers 52 (the right-side portion in FIG. 5), and furthermore a connecting hole 63 is formed in the manifold plate 68 at a position overlapping with the other end portion, in the lengthwise direction, on the opposite side (the left-side portion in FIG. 5). The connecting hole 63 has the same shape as the connecting hole 62 in the spacer plate 66, and is formed in a mutually overlapping position in planar view. Moreover, nozzles 51 are formed in the nozzle plate 70 respectively at positions overlapping with the other end portions, in the lengthwise direction, of the respective pressure chambers 52. The nozzles 51 are formed, for example, by laser excimer processing of a substrate which is made of a resin material, such as polyimide.

As shown in FIG. 5, by bonding the plates 64 to 70 in a laminated state, the common flow channel 55 is connected to the pressure chambers 52 via connecting holes 54, and the pressure chambers 52 are connected to the nozzles 51 via the connecting holes 62 and 63. In this way, an ink flow channel leading from the common flow channel 55 via the pressure chambers 52 to the nozzles 51 is formed inside the flow channel unit 80.

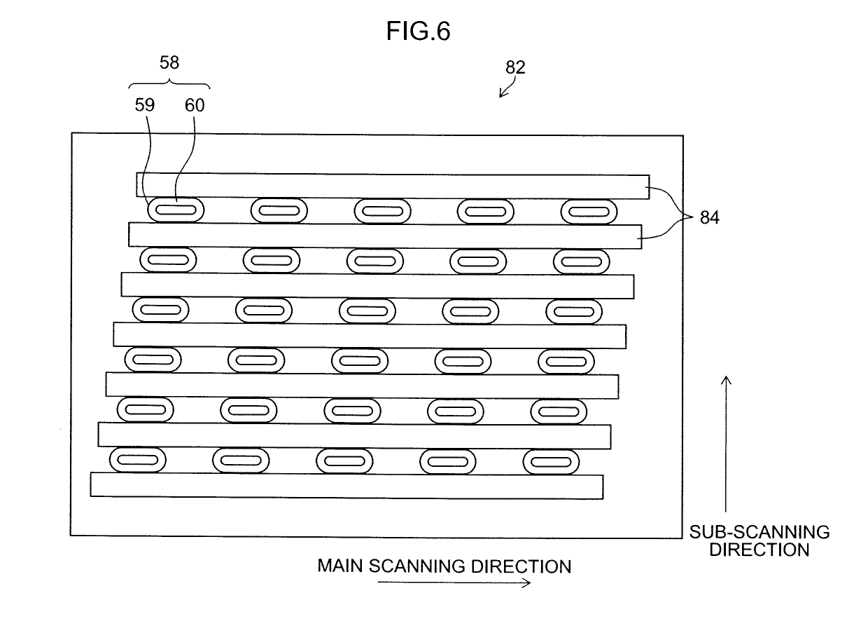

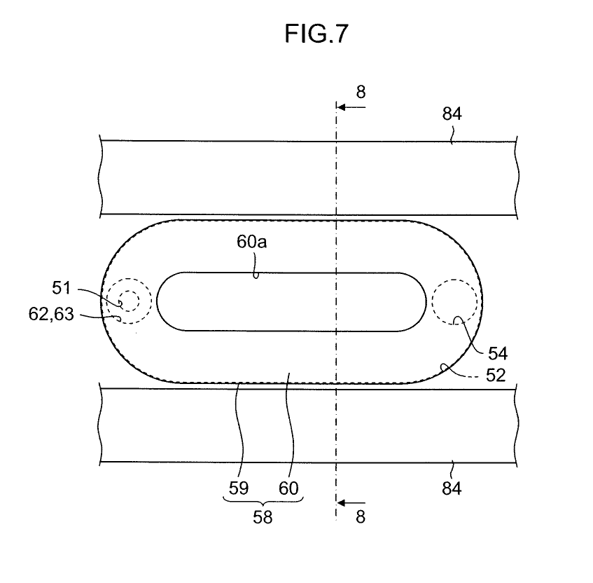

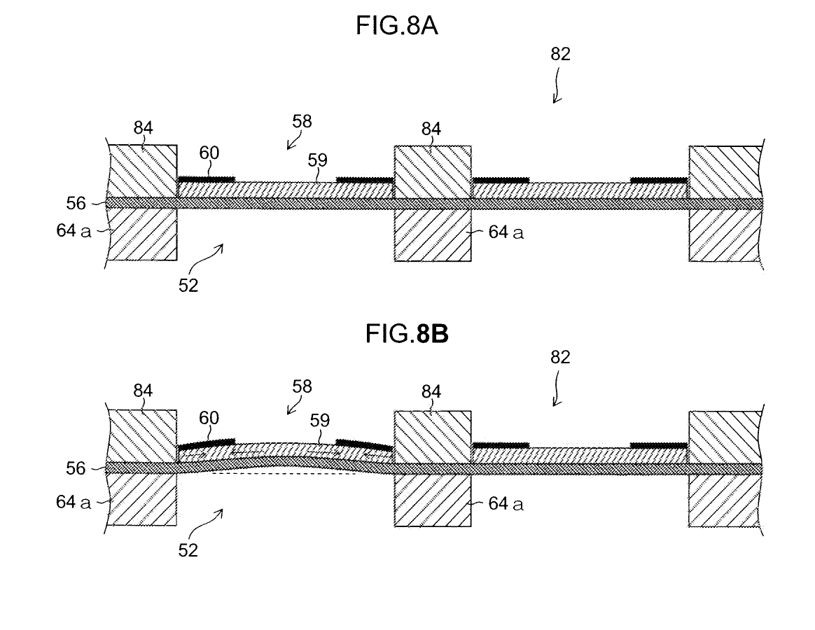

Next, the piezoelectric actuator 82 will be described. FIG. 6 is a plan diagram of the piezoelectric actuator 82, and FIG. 7 is an enlarged plan diagram showing an enlarged portion of the piezoelectric actuator 82. Furthermore, FIGS. 8A and 8B are cross-sectional diagrams showing one portion of the piezoelectric actuator 82 (cross-sectional diagrams along line 8-8 in FIG. 7). In FIGS. 8A and 8B, a portion of the flow channel unit 80 (the pressure chamber plate 64) is also depicted.

As shown in FIG. 5 to FIG. 8B, the piezoelectric actuator 82 comprises a diaphragm 56 which constitutes one wall surface of the respective pressure chambers 52, and a plurality of piezoelectric elements 58 disposed at positions respectively opposing the pressure chambers 52 on the diaphragm 56.

The diaphragm 56 is a thin plate-shaped member having a substantially rectangular planar shape in planar view, which is made of a metal material, such as stainless steel, nickel, aluminium, or the like, and the diaphragm has a thickness of 10 μm, for example. This diaphragm 56 is bonded to the pressure chamber plate 64 so as to cover a plurality of pressure chambers 52, whereby one wall surface of the pressure chambers 52 is constituted by the diaphragm 56. The diaphragm 56 also serves as a common electrode of the plurality of piezoelectric elements 58, and is grounded. Furthermore, the diaphragm 56 may be constituted by a non-conductive material, such as Si, SiO₂, or the like, and an electrode layer forming a common electrode may be formed on the surface of the diaphragm 56.

The piezoelectric elements 58 are each constituted by a piezoelectric body 59 and an individual electrode 60 disposed on the upper surface thereof, and are disposed at positions respectively opposing the pressure chambers 52, on the diaphragm 56.

The piezoelectric bodies 59 have a substantially similar shape to the pressure chambers 52 in planar view, as shown in FIG. 7, and are formed in a substantially oval shape (a substantially elliptical shape) having a longitudinal direction in the main scanning direction. The piezoelectric bodies 59 are made of a piezoelectric material having ferroelectric properties, for example, a ceramic material, such as lead zirconate titanate (PZT), or the like. In particular, in the present example, a piezoelectric film (PZT film) formed by sputtering is used as the piezoelectric bodies 59, and the thickness thereof is 3 to 4 μm, for instance.

Each individual electrode 60 is formed in a ring shape so as to overlap with the marginal part which is the non-central part of the pressure chamber 52, in planar view, as shown in FIG. 7. More specifically, the outer peripheral shape of the individual electrode 60 is a substantially oval shape (substantially elliptical shape) having a long axis in the lengthwise direction of the head (main scanning direction), similarly to the pressure chambers 52 and the piezoelectric bodies 59, and a hole portion 60a of substantially similar shape to this outer peripheral shape is formed in the central portion thereof. The individual electrode 60 is made of a conductive material, such as gold, silver, copper, palladium, platinum, titanium, or the like.

Each of the individual electrodes 60 are electrically connected to a drive circuit (not illustrated) via a flexible printed wiring board (not illustrated), and a drive voltage is applied selectively to the individual electrodes 60 from this drive circuit, via the flexible printed wiring board. The individual electrodes 60 can be formed by screen printing, sputtering, vapor deposition, or the like.

Moreover, as shown in FIGS. 8A and 8B, reinforcing members 84 are provided in the piezoelectric actuator 82 of the present embodiment, at positions opposing the partition portions (pressure chamber partition portions) 64a between the pressure chambers 52 on the diaphragm 56. As shown in FIG. 6 and FIG. 7, the reinforcing members 84 are long thin-shaped members having a lengthwise direction in the main scanning direction, and are aligned with pressure chamber rows 74 which are arranged in the main scanning direction (hereinafter, called “second pressure chamber rows”) (see FIG. 3), the second pressure chamber rows 74 and the reinforcing members 84 being disposed alternately in the sub-scanning direction. In this way, the structure as illustrated in FIGS. 8A and 8B ensures a large amount of displacement of the diaphragm and small cross talk.

There are no particular restrictions on the method of forming the reinforcing members 84, and for example, separate members which form the reinforcing members 84 may be bonded by adhesive, or the like, at prescribed positions on the diaphragm 56, or may be formed on the diaphragm 56 by a film formation method, such as sputtering. Furthermore, there are no particular restrictions on the material of the reinforcing members 84, but a silicon material, metal material, resin material, or the like, is suitable.

Next, the action of the inkjet head 50 will be described.

When a drive voltage is applied to a ring-shaped individual electrode 60 from a drive circuit (not illustrated), then the ring-shaped region of the piezoelectric body 60 sandwiched between the ring-shaped individual electrode 56 and the diaphragm 59 that forms a common electrode contracts in a horizontal direction which is perpendicular to the direction of polarization (the thickness direction of the piezoelectric body 59). Due to the contraction of this ring-shaped region of the piezoelectric body 59, the diaphragm 56 deforms so as to be projected toward the opposite side from the pressure chamber 52, thereby increasing the capacity inside the pressure chamber 52 and producing a pressure wave inside the pressure chamber 52. Moreover, if the application of voltage to the individual electrode 60 is halted at a time when the pressure wave is turning in the positive direction, then the diaphragm 56 returns to its original shape and the volume inside the pressure chamber 52 decreases, and since the pressure wave caused by the increase in the capacity of the pressure chamber 52 described above and the pressure wave occurring due to the returning action of the diaphragm 56 combine together, a large pressure is applied to the ink inside the pressure chamber 52. Consequently, it is possible to apply a high pressure to the liquid by means of a relatively low drive voltage, and the driving efficiency of the piezoelectric actuator 82 is thereby increased.

According to the inkjet head 50 of the present embodiment, since the individual electrodes 60 of the piezoelectric elements 58 are each formed in a ring shape and reinforcing members 84 are disposed at positions corresponding to the pressure chamber partition portions 64a, then it is possible to prevent mechanical cross talk between adjacent pressure chambers by increasing the rigidity of the pressure chamber partition portions 64a by means of the reinforcing members 84, as well as being able to obtain beneficial effects such as the following. More specifically, when a drive voltage is applied to a ring-shaped individual electrode 60, the ring-shaped region of the piezoelectric body 59 contracts in the horizontal direction, the amount of extension from the inside toward the outside becomes greater than the amount of contraction from the outside toward the inside, due to the constricting effect of the reinforcing members 84 which are provided at positions opposing the pressure chamber partition portions 64a, the amount of displacement of the diaphragm 56 is increased compared to a case where the reinforcing members 84 are not provided, and the driving efficiency of the piezoelectric actuator 82 can be further improved.

As described above, since a mode in which ring-shaped individual electrodes are provided and a mode in which reinforcing members are provided at positions corresponding to the pressure chamber partition portions have mutually contradictory beneficial effects, there has been no investigation into the usefulness of combining these modes together.

However, as a result of thorough research carried out by the present inventor, it is discovered for the first time that combining these modes produces beneficial effects which could not be predicted in any way on the basis of conventional technology, namely, that not only is it possible to prevent mechanical cross talk occurring between adjacent pressure chambers, but also the driving efficiency of the piezoelectric actuator can be further improved.

In particular, in the inkjet head 50 according to the present embodiment, since the flexing distortion mode is employed, then the piezoelectric bodies 59 must have a certain surface area and since the thickness of the pressure chamber partition portions 64a becomes relatively thin (for instance, 100 μm or less) if high density arrangement is sought, then it is extremely important to increase the rigidity of the pressure chamber partition portions 64a and hence the aforementioned beneficial effects are more notable.

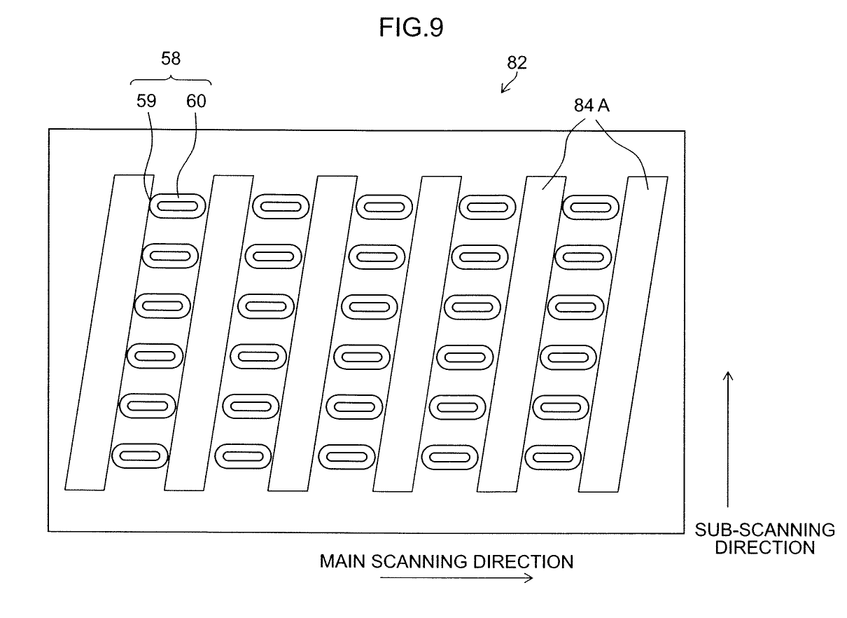

FIG. 9 to FIG. 15 are diagrams showing modification examples of the reinforcing members 84 (first to seventh modification examples).

In a first modification example shown in FIG. 9, the reinforcing members 84A are composed as long thin members having a lengthwise direction in an oblique direction which is not perpendicular to the main scanning direction (more specifically, in the direction of arrangement of the pressure chambers 52 in the first pressure chamber rows 72 (see FIG. 3)), and the first pressure chamber rows 72 and the reinforcing members 84A are arranged in alternating fashion in the main scanning direction.

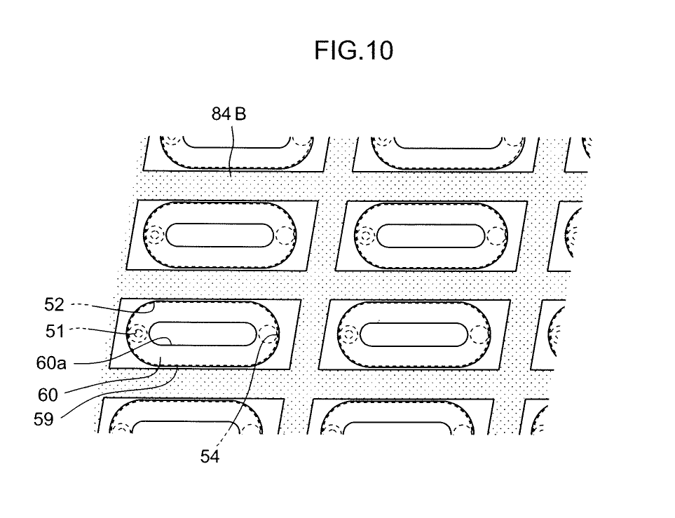

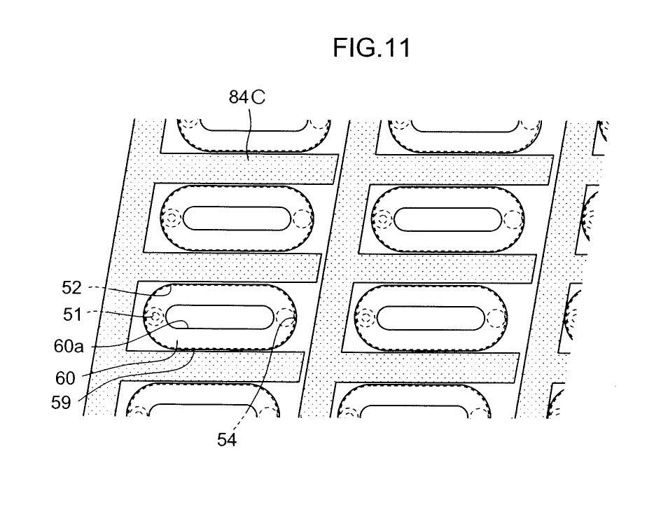

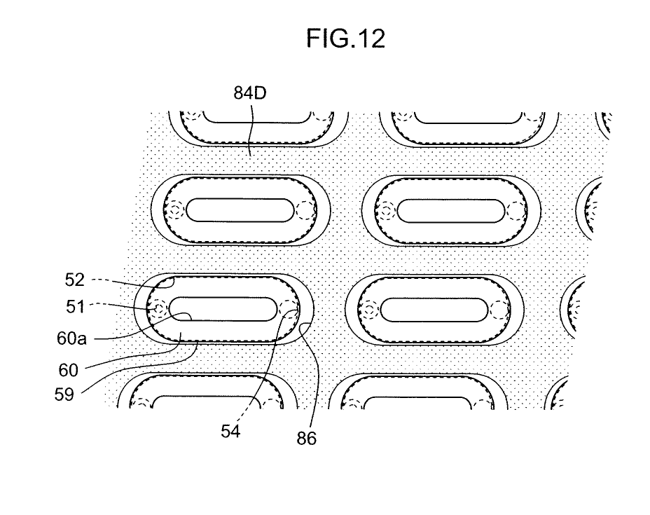

In a second modification example shown in FIG. 10, the reinforcing members 84B are formed in a lattice shape so as to encompass the entire outer periphery of the pressure chambers 52 in planar view. Furthermore, in a third modification example shown in FIG. 11, a plurality of comb-tines-shaped reinforcing members 84C are formed in a lattice shape so as to encompass the entire outer periphery of the pressure chambers 52 in planar view. More specifically, in the present modification example, the reinforcing members 84B shown in FIG. 10 are each divided into a plurality of comb-tines-shaped members. Moreover, in a fourth modification example shown in FIG. 12, the reinforcing members 84D are tabular members in which pore portions 86 are formed at positions overlapping with the pressure chambers 52 in planar view. According to the second to fourth modification examples, it is possible to prevent effectively mechanical cross talk between pressure chambers 52 which are adjacent in the main scanning direction and in an oblique direction that is not perpendicular to the main scanning direction, and it is also possible further to improve the driving efficiency of the piezoelectric actuator 82 since the piezoelectric bodies 59 contract in a uniform fashion.

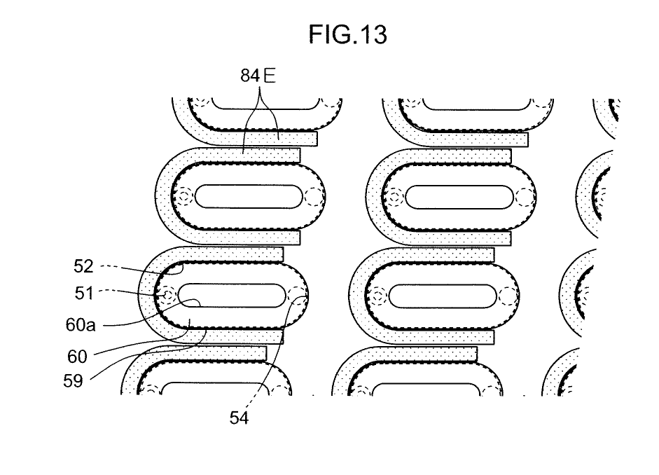

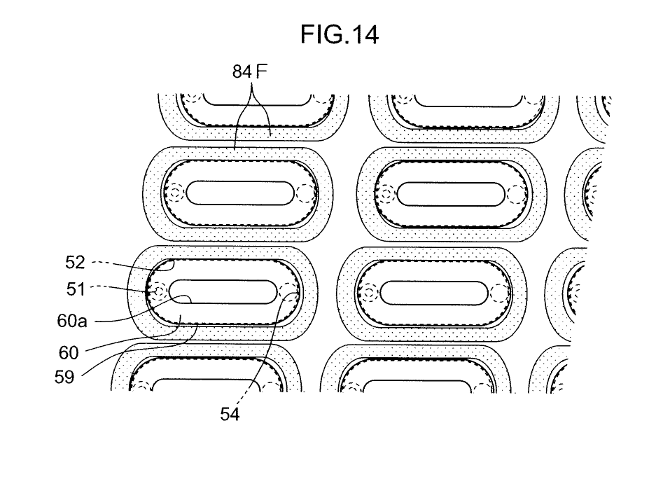

In a fifth modification example shown in FIG. 13, U-shaped reinforcing members 84E in planar view are provided at the pressure chambers 52 respectively. Furthermore, in a sixth modification example shown in FIG. 14, reinforcing members 84F formed in a ring shape (donut shape) in planar view) are provided at the pressure chambers 52 respectively. There are no particular restrictions on the shape of the ring-shaped reinforcing members 84F, which may have a circular, elliptical, quadrilateral or other polygonal shape. According to these modification examples, the reinforcing members 84E or 84F are formed independently with respect to each pressure chamber 52, and therefore it is possible to prevent mechanical cross talk yet more effectively.

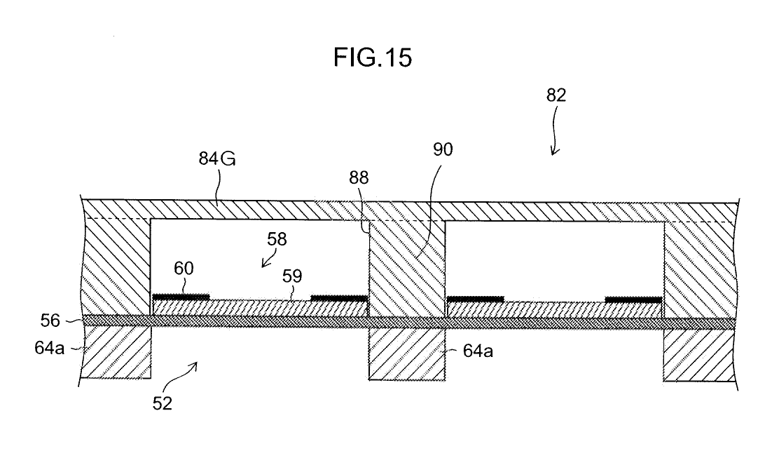

The reinforcing member 84G in a seventh modification example shown in FIG. 15 has a cavity configuration in which a plurality of cavities (recesses) 88 are formed respectively at positions corresponding to the pressure chambers 52. The partition portions 90 between the cavities 88 are disposed respectively at positions opposing the pressure chamber partition portions 64a. According to this modification example, the interior of each cavity 88 has a sealed structure housing a piezoelectric element 58, and hence the composition serves to protect the piezoelectric elements 58 from humidity. Furthermore, by forming a protective film on the surface of the piezoelectric elements 58, it is also possible to utilize the interiors of the cavities 88 as ink flow channels.

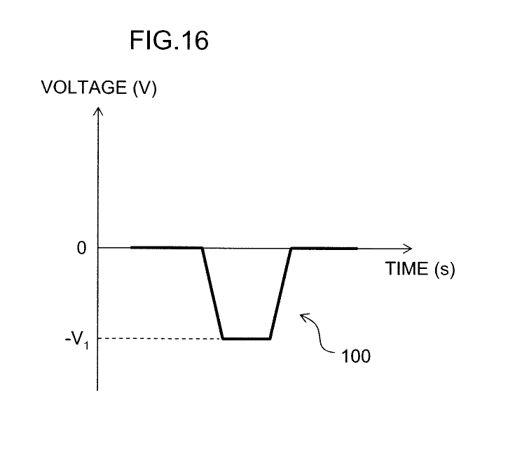

In the inkjet head 50 according to the present embodiment, since piezoelectric bodies (PZT) 59 formed by sputtering are used as described above, beneficial effects of the following kind are also obtained. More specifically, the direction of polarization of a piezoelectric body (PZT) 59 formed by sputtering is opposite to normal and is a direction from the diaphragm 56 forming the common electrode toward the individual electrode 60 (the upward direction in FIGS. 8A and 8B). Therefore, in order to cause an electric field to act in the same direction as the direction of polarization of the piezoelectric body 59, if the diaphragm 56 is grounded and taken to have a potential of 0 (V), then it is necessary to apply a drive voltage so that the individual electrodes 60 assumes a negative potential. The drive method used in this case is such that the potential of the individual electrode 60 is 0 (V) and the diaphragm 56 is not deformed, in normal circumstances apart from when an ink ejection operation is being performed, as in the drive voltage waveform 100 shown in FIG. 16. After the start of an ink ejection operation, the potential is changed from 0 (V) to −V₁ (V) (where V₁>0), and the diaphragm 56 is caused to deform in a projected shape toward the opposite side from the pressure chamber 52. In so doing, ink is drawn into the pressure chamber 52 via the supply port 54. After a prescribed time period has elapsed (in other words, at the timing that the pressure wave generated inside the pressure chamber 52 switches to positive), the potential of the individual electrode 60 is changed from −V₁ (V) to 0 (V), the diaphragm 56 is caused to return, and the ink inside the pressure chamber 52 is thereby pressurized, so as to eject an ink droplet from the nozzle 51.

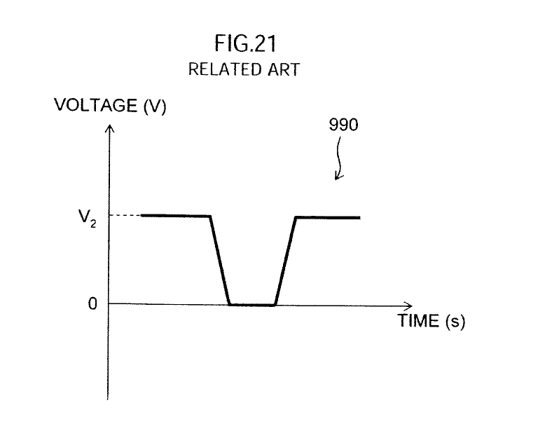

On the other hand, in the case of a general structure in which the direction of polarization of the piezoelectric bodies 59 acts from the individual electrode 60 toward the diaphragm 56 which forms a common electrode (the downward direction in FIGS. 8A and 8B), if the diaphragm 56 is set to deform in a projected shape toward the pressure chamber 52 by setting the potential of the individual electrode 60 to V₂ (V) (where, V₂>0) under normal circumstances, as in the drive voltage waveform 990 shown in FIG. 21, then after the start of an ink ejection operation, the potential is changed from V₂ (V) to 0 (V) and the diaphragm 56 is changed to its state before deformation. In so doing, ink is drawn into the pressure chamber 52 via the supply port 54. When a prescribed time period has elapsed, the potential of the individual electrode 60 is changed from 0 (V) to V₂ (V), the diaphragm 56 is returned to its original deformed state, the ink inside the pressure chamber 52 is pressurized, and an ink droplet is ejected from the nozzle 51.

In this way, according to the present embodiment, under normal circumstances apart from when an ink ejection operation is being performed, no drive voltage is applied to the individual electrode 60 and no electric field acts on the piezoelectric bodies 59 in this case. Therefore, it is possible to prevent deterioration of the piezoelectric bodies 59 and hence this drive method is desirable from the viewpoint of reliability.

When implementing the present invention, the arrangement structure of the nozzles is not limited to the example shown in the drawings, and it is also possible to apply various other types of nozzle arrangements, such as an arrangement structure having one nozzle row in the sub-scanning direction.

Furthermore, the scope of application of the present invention is not limited to a printing system based on a line type of head, and it is also possible to adopt a serial system where a short head which is shorter than the breadthways dimension of the recording paper 16 is scanned in the breadthways direction (main scanning direction) of the recording paper 16, thereby performing printing in the breadthways direction, and when one printing action in the breadthways direction has been completed, the recording paper 16 is moved through a prescribed amount in the direction perpendicular to the breadthways direction (the sub-scanning direction), printing in the breadthways direction of the recording paper 16 is carried out in the next printing region, and by repeating this sequence, printing is performed over the whole surface of the printing region of the recording paper 16.

### Structure of Control System

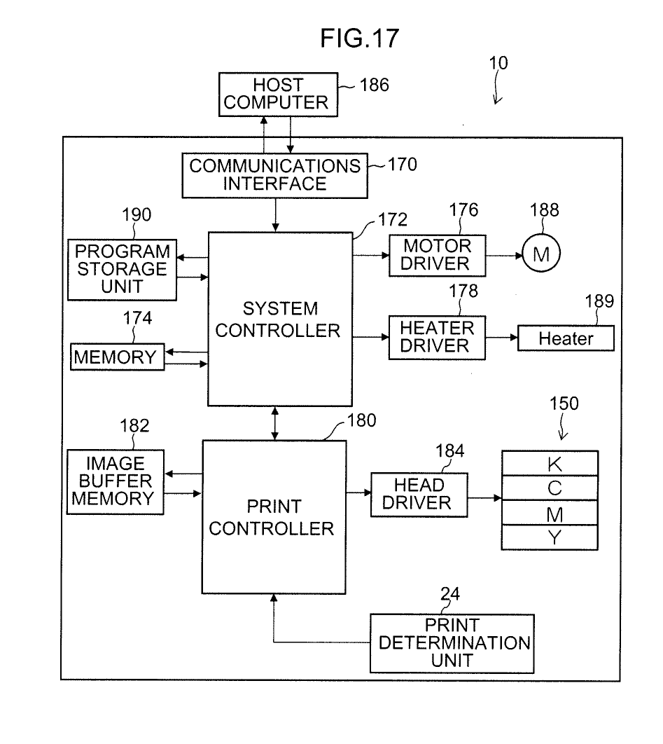

FIG. 17 is a principal block diagram showing a control system configuration of the inkjet recording apparatus 10. The inkjet recording apparatus 10 includes a communications interface 170, a system controller 172, an image memory 174, a motor driver 176, a heater driver 178, a print controller 180, an image buffer memory 182, a head driver 184, and the like.

The communications interface 170 is an interface unit for receiving image data sent from a host computer 186. USB (Universal Serial Bus), IEEE 1394, Ethernet, a serial interface such as wireless network or a parallel interface such as Centronics may be used as the communications interface 170. A buffer memory (not shown) may be mounted in this portion in order to increase the communication speed.

The image data sent from the host computer 186 is received by the inkjet recording apparatus 10 through the communications interface 170, and is temporarily stored in the image memory 174. The image memory 174 is a storage device for temporarily storing images inputted through the communications interface 170, and data is written and read to and from the image memory 174 through the system controller 172. The image memory 174 is not limited to a memory composed of semiconductor elements, and a hard disk drive or another magnetic medium may be used.

The system controller 172 is a control unit which controls the respective sections, such as the communications interface 170, the image memory 174, the motor driver 176, the heater driver 178, and the like. The system controller 172 is made up of a central processing unit (CPU) and peripheral circuits thereof, and as well as controlling communications with the host computer 186 and controlling reading from and writing to the image memory 174, and the like, it generates control signals for controlling the motors 188 and heaters 189 in the conveyance system.

The memory 174 stores programs which are executed by the CPU of the system controller 172 and various data which is required for control procedures. The memory 174 may be a non-rewriteable storage device, or it may be a writeable storage device such as EEPROM. The memory 174 is used as a temporary storage region for the image data, and it is also used as a program development region and a calculation work region for the CPU.

Various control programs are stored in the program storage unit 190, and a control program is read out and executed in accordance with commands from the system controller 172. The program storage unit 190 may use a semiconductor memory, such as a ROM or EEPROM, or a magnetic disk, or the like. An external interface may be provided, and a memory card or PC card may also be used. Naturally, a plurality of these recording media may also be provided. The program storage unit 190 may also be combined with a storage device for storing operational parameters, and the like (not illustrated).

The motor driver (drive circuit) 176 drives the motor 188 in accordance with commands from the system controller 172. The heater driver 178 drives the heater 189 of the post-drying unit 42 or other units in accordance with commands from the system controller 172.

The print controller 180 has a signal processing function for performing various tasks, compensations, and other types of processing for generating print control signals from the image data stored in the image memory 174 in accordance with commands from the system controller 172 so as to supply the generated print control signal (dot data) to the head driver 184. Prescribed signal processing is carried out in the print controller 180, and the ejection amount and the ejection timing of the ink droplets from the respective printing heads 50 are controlled via the head driver 184, on the basis of the print data. By this means, desired dot size and dot positions can be achieved.

The print controller 180 is provided with the image buffer memory 182; and image data, parameters, and other data are temporarily stored in the image buffer memory 182 when image data is processed in the print controller 180. The aspect shown in FIG. 17 is one in which the image buffer memory 182 accompanies the print controller 180; however, the image memory 174 may also serve as the image buffer memory 182. Also possible is an aspect in which the print controller 180 and the system controller 172 are integrated to form a single processor.

The head driver 184 generates drive signals for driving the piezoelectric elements 58 (see FIG. 5) of the recording heads 50 of the respective colors, on the basis of dot data supplied from the print controller 180, as well as supplying the generated drive signals to the heaters 58 (or piezoelectric elements 58′). A feedback control system for maintaining constant drive conditions in the head 50 may be included in the head driver 184.

The print determination unit 24 is a block including a line sensor as explained with reference to FIG. 1, and reads in an image printed on the recording medium 16 and performs required signal processing, and the like, to determine the recording status (presence or absence of ejection, fluctuation of ejection, and the like). The determination results are sent to the print controller 180.

According to requirements, the print controller 180 makes various corrections with respect to the head 50 on the basis of information obtained through the print determination unit 24.

The embodiments described above show the examples in which the present invention is applied to an inkjet head which ejects ink from nozzles, but the object of application of the present invention is not limited to an inkjet head of this kind For example, the present invention can be applied to various liquid ejection heads, such as those used to form fine wiring patterns on a substrate by ejecting a conductive paste, or form a high-definition display by ejecting organic light-emitting bodies onto a substrate, or form very small electronic devices, such as light guides, by ejecting optical resin onto a substrate.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid ejection head comprising: a flow channel unit including a plurality of pressure chambers arranged along a plane surface; and a piezoelectric actuator for changing volume of the plurality of pressure chambers so as to pressurize liquid in the plurality of pressure chambers,
the piezoelectric actuator comprising:
a diaphragm forming one wall surface of the plurality of pressure chambers;
a plurality of piezoelectric bodies arranged on first regions of the diaphragm that are within a surface of the diaphragm opposite from the plurality of pressure chambers, the first regions overlapping with the plurality of pressure chambers respectively when viewed in a direction perpendicular to the plane surface;
a plurality of individual electrodes arranged on second regions of one surface of the plurality of piezoelectric bodies respectively, the second regions overlapping with marginal parts of the plurality of pressure chambers that are non-central parts of the plurality of pressure chambers when viewed in the direction perpendicular to the plane surface;
a common electrode arranged on another surface of the plurality of piezoelectric bodies; and
a reinforcing member arranged on third regions of the diaphragm that are within the surface of the diaphragm opposite from the plurality of pressure chambers, the third regions respectively overlapping with pressure chamber partition portions between the plurality of pressure chambers when viewed in the direction perpendicular to the plane surface.

2. The liquid ejection head as defined in claim 1, wherein:
the plurality of pressure chambers are two-dimensionally arranged in a first direction and a second direction that is oblique to the first direction and is not perpendicular to the first direction, and
the reinforcing member is arranged on the third regions that respectively overlap with the pressure chamber partition portions between the plurality of pressure chambers that are adjacent in at least one of the first direction and the second direction when viewed in the direction perpendicular to the plane surface.

3. The liquid ejection head as defined in claim 2, wherein the reinforcing member is an elongated member which is arranged in parallel with a row of the pressure chambers arranged in the first direction or the second direction.

4. The liquid ejection head as defined in claim 2, wherein the reinforcing member is a lattice-shaped member which encompasses entire periphery parts of the plurality of pressure chambers respectively when viewed in the direction perpendicular to the plane surface.

5. The liquid ejection head as defined in claim 4, wherein the reinforcing member is divided into comb-tines-shaped members.

6. The liquid ejection head as defined in claim 2, wherein the reinforcing member is made from a tabular member having pore portions that are arranged respectively in fourth regions of the tabular member, the fourth regions overlapping with the plurality of pressure chambers when viewed in the direction perpendicular to the plane surface.

7. The liquid ejection head as defined in claim 1, wherein the reinforcing member is composed of individual reinforcing members which are each provided with respect to each of the plurality of pressure chambers.

8. The liquid ejection head as defined in claim 7, wherein the individual reinforcing members are U-shaped members which surround periphery parts of the plurality of pressure chambers respectively when viewed in the direction perpendicular to the plane surface.

9. The liquid ejection head as defined in claim 7, wherein the individual reinforcing members are ring-shaped members which encompass entire periphery parts of the plurality of pressure chambers respectively when viewed in the direction perpendicular to the plane surface.

10. The liquid ejection head as defined in claim 1, wherein the reinforcing member has a cavity configuration in which recesses for housing the plurality of piezoelectric bodies and the plurality of individual electrodes that are arranged opposite from the plurality pressure chambers respectively.

11. The liquid ejection head as defined in claim 10, wherein the reinforcing member seals the plurality of piezoelectric bodies and the plurality of individual electrodes in the recesses in such a manner that an ambient air is prevented from leaking into the recesses.

12. The liquid ejection head as defined in claim 10, further comprising a protect film provided on the piezoelectric actuator in such a manner that the protect film protects the piezoelectric actuator from at least the liquid.

13. The liquid ejection head as defined in claim 1, wherein the plurality of individual electrodes have a ring shape.

14. The liquid ejection head as defined in claim 1, wherein the plurality of piezoelectric bodies are made by sputtering.

15. The liquid ejection head as defined in claim 1, wherein the plurality of piezoelectric bodies employ a flexing vibration mode.

16. A liquid ejection apparatus comprising the liquid ejection head defined in claim 1,
wherein in the liquid ejection head, the plurality of individual electrodes on the second regions of the one surface of the plurality of piezoelectric bodies are arranged opposite from the diaphragm, the common electrode is grounded, and the plurality of piezoelectric bodies are polarized in a direction from the diaphragm toward the plurality of individual electrodes, and
wherein the liquid ejection apparatus further comprises a voltage application device which applies a voltage having a driving voltage waveform with negative potential in such a manner that an electric field acting in a same direction as the direction in which the plurality of piezoelectric bodies are polarized is produced only during operation to eject the liquid.

17. The liquid ejection apparatus as defined in claim 16, further comprising a controller controlling the voltage application device in such a manner that a plurality of pressure waves in the liquid in the plurality of pressure chambers which are produced by volume change of the pressure chambers caused by the piezoelectric actuator are combined together to eject the liquid from the liquid ejection head.

18. An image forming apparatus comprising the liquid ejection head defined in claim 1.
